(19) United States
(12) Patent Application Publication
(10) Pub. No.: US 2016/0364080 A1
(43) Pub. Date: Dec. 15, 2016

(54) METHOD AND SYSTEM FOR CORRECTING TARGET-INACCURATE INPUT APPLIED TO AN INPUT DEVICE

(71) Applicant: Yissum Research Development Company of The Hebrew University of Jerusalem Ltd., Jerusalem (IL)

(72) Inventors: Aviva DAYAN, Jerusalem (IL); Ido ELAD, Jerusalem (IL); Yuval KOCHMAN, Tel-Aviv (IL)

(21) Appl. No.: 15/181,678

(22) Filed: Jun. 14, 2016

Related U.S. Application Data
(60) Provisional application No. 62/175,392, filed on Jun. 14, 2015.

(51) Int. Cl. G06F 3/041; G06F 3/01

(52) U.S. Cl. CPC G06F 3/0418; G06F 3/017; G06F 3/013

(57) ABSTRACT

A method and a system for estimating the intended position of at least one target-inaccurate user inputs applied by a user to an input device are provided herein. The method may include the following steps: analyzing one or more points of contact applied to a an input device, to derive input parameters associated with the user inputs; applying a decision function to the derived input parameters, to estimate an intended position of the at least one target-inaccurate input of the user, wherein the decision function is tailored for the user and is further based on user parameters associated with the user; and overriding, at a level of the input device, the actual user inputs with the estimated intended position of the at least one target-inaccurate input of the user.

### CROSS-REFERENCE TO RELATED APPLICATIONS

This application claims priority from U.S. Provisional Patent Application No. 62/175,392, filed on Jun. 14, 2015, which is incorporated herein by reference in its entirety.

### FIELD OF THE INVENTION

The present invention relates generally to the field of haptic and gestural interfaces, and more particularly to correcting target-inaccurate input in such interfaces.

### BACKGROUND OF THE INVENTION

Prior to describing the background of the invention, it may be helpful to set forth definitions of certain terms that will be used hereinafter.

The term ‘haptic interface’ refers to an interface controlled by tactile sensations.

The term ‘gestural interface’ refers to an interface controlled by gestures, such as eye movements.

The term ‘single input event’, as used herein is defined as the sets of inputs applied either as a sequence or concurrently by a user to a haptic or gestural interface mechanism from the moment the user initiates an attempt to interact with the user interface till the user has finished the attempt. It is understood that more than one actual sets of inputs may occur during a single input event, some of which may be unintentional in nature.

The term ‘target-inaccurate input’ used herein refers to any inconsistencies of interaction, whether resulting from the user's physical condition or because of environmental, mechanical or other factors.

The term ‘touchscreen’, as used herein is defined any touch-sensitive input device accompanied by an electronic visual display and an information processing system. A user can interact with the information processing system through single or multi-touch gestures by touching the screen with one or more of his or her body parts (e.g. fingers) or any object coupled thereto. Touchscreens are illustrative non-limiting examples of input devices that may be affected by target-inaccurate input (e.g. a target-inaccurate touch).

The term ‘tremor’ used herein refers to an interference in the user input, such that the intended input is disrupted by noise. Some target-inaccurate input are caused due to muscular tremor.

With the popularity of smartphones and other touch sensitive consumer electronic devices as well as natural user interface (NUI) devices, the ability to properly use these devices is significantly undermined in the case of target-inaccurate inputs. The main problem in target-inaccurate input is identifying the location, intensity and duration as originally intended by the user, out of the actual user-interface interaction. Some undesirable target-inaccurate input events contain a plurality of unintentional inputs, while other target-inaccurate input events may include locational displacement or irregular intensity.

While some interfaces have a mechanism for calibrating the sensor array vis-à-vis the display for correcting a potential software or hardware misalignment under the assumption of a non-shaky user, none of the known solutions addresses misalignments on the physiological side of the user, a shaky environment or a shaky input device.

### SUMMARY OF THE INVENTION

In accordance with some embodiments of the present invention, a method and a system for estimating the intended position of at least one target-inaccurate set of inputs applied by a user to a haptic or gestural input device (such as a touchscreen) are provided herein. The method may include the following steps: analyzing one or more target-inaccurate sets of inputs applied to a haptic or gestural input device during a single input event, deriving parameters which characterize the sets of inputs; and applying a function to the parameters and to additional parameters which may or may not be associated with the user, the device, or socially gleaned information; using the results of the function to override the actual sets of input with an estimate of the intended position of the target-inaccurate sets of inputs, as derived from the function.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a non-limiting exemplary system in accordance with embodiments of the present invention;

FIG. 2 is a block diagram illustrating a an aspect of the system in accordance with embodiments of the present invention;

FIG. 3 is a flowchart diagram illustrating a non-limiting exemplary method in accordance with embodiments of the present invention and

FIG. 4A is diagram illustrating an aspect of the touch screen according to some embodiments of the present invention;

FIG. 4B is diagram illustrating another aspect of the touch screen according to some embodiments of the present invention; and

FIG. 5 is diagram illustrating yet another aspect of the touch screen according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

It should be understood that the examples relating to tremor described herein are merely illustrative and non-limiting in nature. A person skilled in the art will easily be able to adapt the principles and implementation described in connection with tremor to address other forms of inaccurate target touch.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar computing device, that manipulates and/or transforms data represented as physical, such as electronic, quantities within the computing system's registers and/or other memories into other data similarly represented as physical quantities within the computing system's memories, registers or other such information storage, transmission or display devices.

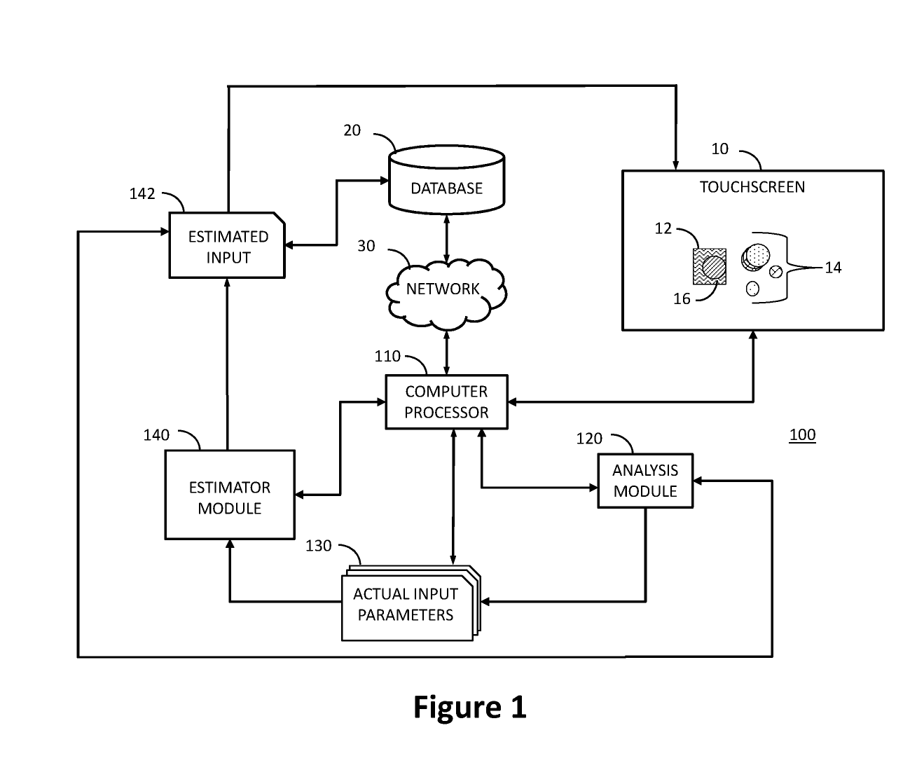

FIG. 1 is a block diagram illustrating a non-limiting exemplary system 100 for estimating the intended position of at least one target-inaccurate input (e.g. of a touch by a finger) by a user applied to an input device such as a touchscreen 10. System 100 may include a computer processor 110 (which may be the computer processor of input device 10). System 100 may further include an analysis module 120 executed as a software module by computer processor 110 and configured to analyze one or more actual sets of inputs 14 or interactions applied to input device 10 preferably applied during a single input event. The analysis by analysis module 120 derives actual input parameters 130 which characterize various features of the applied actual sets of inputs 14 as will be described in details hereinafter.

In some non-limiting exemplary embodiments of the present invention, actual input parameters 130 may be in a form of a time series in which a plurality of metrics characterizing the physical properties of the input (e.g. touch input) are recorded on a time scale. Such metrics may include X-Y position, size, shape, duration, intensity, and plurality of simultaneous X-Y positions (e.g. multi-touch) among other metrics. It is understood that the aforementioned metrics may assume different formats and a time series implementation should not be regarded as limiting.

System 100 may further include an estimator module 140 executed as a software module executed by computer processor 110. Estimator module 140 may be fed with actual input parameters 130 as derived from the actual sets of inputs 14 by analysis module 120 and based on a data which is specific to the user associated with actual sets of inputs 14, possibly derived from a database 20 is configured to estimate the intentional position 142 of the target-inaccurate input of the specific user. In other words estimator module 140 maps on the X-Y plane of touchscreen 10, (or X-Y-Z space in a case of a 3D NUI input device) actual sets of inputs 14 to intended position (estimated input 142). In order to accomplish that, data on database 20 is user-specific and may contain parameters derived during an earlier calibration or training session with the specific user or my other means as will be described hereinafter.

In some embodiments of the present invention, the estimation at estimator module 140 may be implemented by a decision function which may be tailored by itself for the specific user (or a user-input device interaction) and is further based on user parameters which characterize a mobility irregularity associated with the user (or in case of a user-input device interaction, an irregularity related to the interaction). These user-specific parameters may be derived earlier during a training or a calibration session and may be stored on database 20 preferably located remotely and accessible via a network 30 (e.g., from a cloud).

In accordance with some embodiments of the present invention, after an estimation indicative of the intended position of the sets of inputs applied by the user is calculated, the computer processor 110 may be configured to override, via corresponding input controllers (not shown here) at input device 10, the actual sets of inputs with the aforementioned estimated intended position of the user input.

According to some embodiments of the present invention, actual touch parameters 130 may include time stamped metrics of at least one of: X-Y position, size, duration, intensity and orientation. The metrics may be further indicative of more complicated input events such as postures (deliberate multi touch of a specified finger alignment) and gestures (a sequence of postures expressing a predefined movement) as well as gaze position and eye movements.

According to some embodiments of the present invention, the user parameters on database 20 may include metrics indicative of his or her mobility irregularity and include at least one of: X-Y drift, multiplicity of touch, and any other movement irregularity such as tremor magnitude or any other clinical external movement related manifestation of the physiological condition.

According to some embodiments of the present invention, computer processor 110 may obtain parameters associated with the user via a calibration session that may include providing the user with a task to apply specific input activity on predefined X-Y locations or predefined postures and gestures and monitoring and analyzing the input events carried by the user over input device 10.

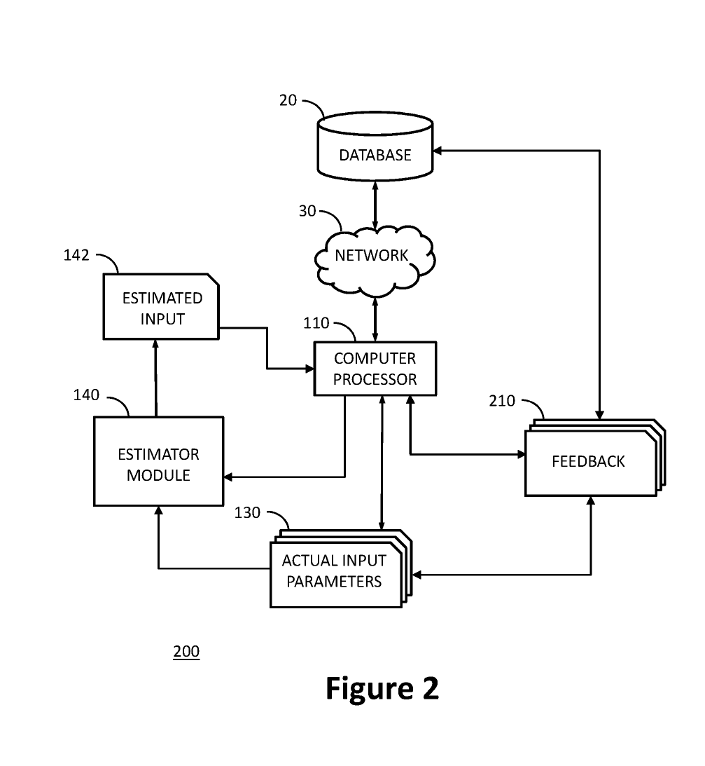

FIG. 2 is a block diagram illustrating an aspect of the system discussed herein in accordance with embodiments of the present invention. Architecture 200 illustrates a subset of aforementioned system 100 and includes computer processor 110, database 20 connected via network 30 to computer processor 110. Estimator module 140 executed by computer processor 110 and fed by actual input parameters 130.

In some embodiments, and preferably in an off-line process, once estimator module 140 produces an estimated touch 142, feedback 210 pertaining to the correctness of the estimation process is provided to computer processor 110 which then, possibly in combination with database 20 improves estimator module 140. Thus, the decision function (or any other estimation mechanism implemented by estimator module 140) may be updated after each feedback provided. The feedback may be either explicit (by a user) or implicit by monitoring the usage pattern right after actual use of estimator module 140.

In accordance with some embodiments of the present invention, the offline processing also allows for the consideration of social information such as similar tremor traits, hand size, age, condition, and further allows the use of databases of a plurality of users and implementing deep learning using crowd sourcing of user parameters for improving the estimation algorithm.

In accordance with some embodiments of the present invention, estimation of the user input (in a case of touch—point of contact) may be extended to estimation of gestures being a sequence of user inputs. In such a case, the decision function may further take into account the gestural grammar of the user (such as the fact that an arm can only rotate on two axis points).

In accordance with some embodiments of the present invention offline processing component implemented by computer processor 110, and storage component such as database 20 may handle machine learning and/or big data aspects and feed insights gleaned as appropriate. Additionaly, database 20 may also be used for quality assessments.

In accordance with some embodiments of the present invention the training or calibration session may also be carried out or re-done during normal use using input from the users usage patterns. Socially gleaned information as well as improvements to the decision function and its parameters may also be pushed/pulled from remote servers located on the cloud to improve performance on the fly.

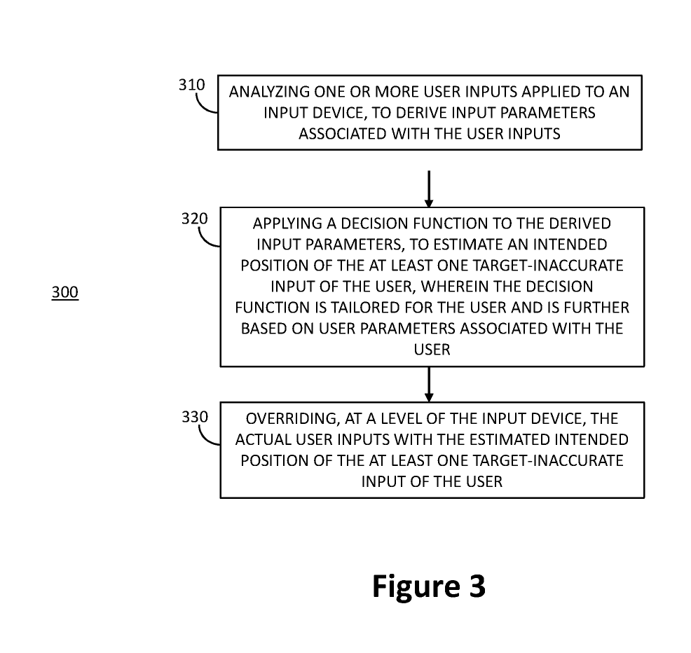

FIG. 3 is a flowchart diagram illustrating a non-limiting exemplary method of estimating an intentional position of at least one target-inaccurate input of a user over an input device, in accordance with embodiments of the present invention. Method 300 may include the following steps: analyzing one or more user inputs applied to an input device, to derive input parameters associated with the user inputs 310; applying a decision function to said derived input parameters, to estimate an intended position of the at least one target-inaccurate input of the user, wherein the decision function is tailored for the user and is further based on user parameters associated with the user 320; and overriding, at a level of the input device, the actual user input with the estimated intended position of the at least one target-inaccurate input of the user 330.

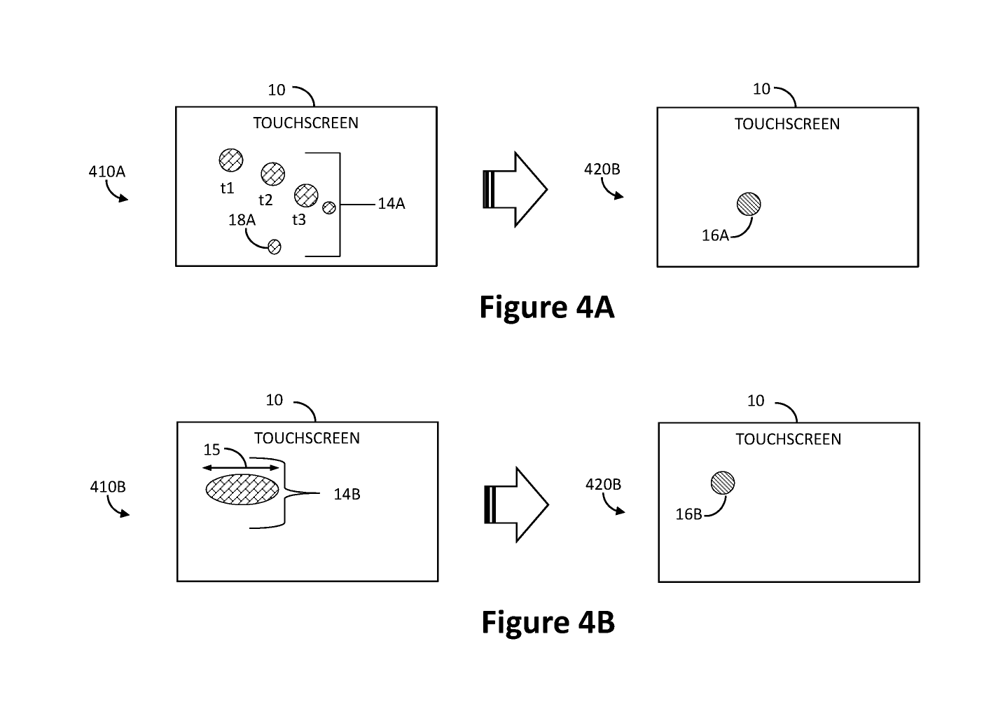

FIG. 4A is a diagram illustrating an example for the mapping of the input to the output carried out by the estimation process according to some embodiments of the present invention. Input diagram 410A shows various points of contact 14A applied to touchscreen 10. It is noted that each of the points of contact can be applied at different time stamps (e.g. t₁, t₂, t₃) and may also include at least one point that is due to an unintentional touch 18A. Output diagram 420B shows the estimated intended location 16A.

FIG. 4B is a diagram illustrating an example for the mapping of the input to the output carried out by the estimation process according to some embodiments of the present invention. Input diagram 410B shows various points of contacts 14B applied to touchscreen 10. It is noted that actual point of touch 14B may be comprised of many undistinguishable points of contact that form an ellipsoid along vector 15. Vector 15 may be used to derive touch parameters used in the estimation process. Output diagram 420B shows the estimated intended location 16B.

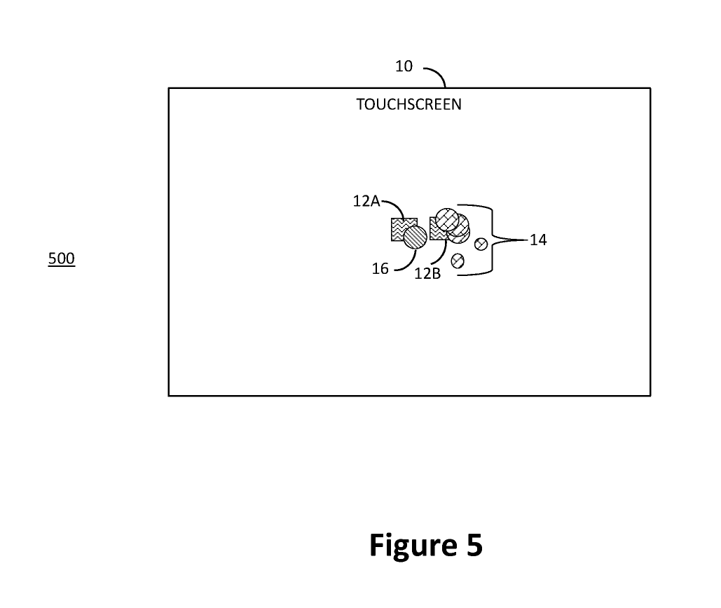

FIG. 5 is a diagram illustrating a non-limiting aspect in accordance with embodiments of the present invention. In case the input device 10 is a touch screen, the decision function may take into account virtual objects presented on the touch screen proximal to the X-Y location of the actual finger touches. For example, icons 12A and 12B are proximal to actual finger touches 14. The decision where estimated intention touch 16 may be affected inter alia by the content of icons 12A and 12B and possibly by the context of the user's prior touches so the decision function is effectively aware of the user's usage semantics and not just the touch locations.

In order to implement the method according to embodiments of the present invention, a computer processor may receive instructions and data from a read-only memory or a random access memory or any combination of any types of memory. At least one of aforementioned steps is performed by at least one processor associated with a computer. The essential elements of a computer are a processor for executing instructions and one or more memories (including cloud-based memories) for storing instructions and data, as well as input and output mechanisms. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices, whether on-board or stored remotely such as with cloud services.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, or machine language, assembler, or any other means of programming a device. The program code may execute entirely on the user's computer, partly on the user's computer, as a stand-alone software package, partly on the user's computer and partly on one or more remote computer(s) or entirely on the remote computer(s) or server. In the latter scenario, the remote computer(s) may be connected to the user's computer through any type of network, including a local area network (LAN) or a wide area network (WAN), or the connection may be made to an external computer(s) (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for estimating an intended position of at least one target-inaccurate input of a user over a gestural or haptic input device, the system comprising:
a gestural or haptic input mechanism;
a computer processor;
an analysis module executed by said computer processor configured to analyze one or more actual points of interaction associated with said target-inaccurate input, over said input device, to derive parameters;
an estimator module executed by said computer processor configured to apply a decision function to said derived parameters, to estimate the intended input from among the at least one target-inaccurate sets of input of said user, wherein the decision function may be tailored for said user and may be further based on parameters associated with said user.

2. The system according to claim 1, wherein the computer processor is configured to override, at the touch-sensitive input device level, the actual points of input with the estimated intended position of at least one target-inaccurate input set of said user.

3. The system according to claim 1, wherein the parameters comprise time stamped metrics of at least one of: X-Y position, size, duration, intensity and orientation.

4. The system according to claim 1, wherein the computer processor is further configured to obtain the parameters associated with the user via a calibration session that comprises monitoring predefined input events carried by the user over the input device.

5. The system according to claim 1, wherein the computer processor is further configured to obtain the parameters associated with the user by monitoring usage patterns of said user.

6. The system according to claim 1, wherein the input device is a touch screen.

7. The system according to claim 1, wherein the input device is an eye-movement detector.

8. The system according to claim 7, wherein the decision function takes into account a virtual object presented on the touch screen proximal to the X-Y location of the actual points of contact.

9. A method of estimating an intentional position of at least one target-inaccurate set of inputs of a user over an input device, the method comprising:
analyzing one or more sets of input applied to an input device, to derive parameters associated with said points of contact;
applying a decision function to said derived parameters, to estimate an intended position of the at least one target-inaccurate sets of input of said user, wherein the decision function is tailored for said user and is further based on user parameters associated with said user; and
overriding, at a level of the input device, the actual sets of user input with the estimated intended position of the at least one target-inaccurate sets of input of said user.

10. The method according to claim 9, wherein the touch parameters comprise time stamped metrics of at least one of: X-Y position, size, duration, intensity and orientation.

11. The method according to claim 9, wherein the user parameters comprise at least one of: X-Y drift, multiplicity of touch; intensity, duration, and tremor magnitude.

12. The method according to claim 9, further comprising obtaining the user parameters via a calibration session that comprises monitoring predefined touch events carried by the user over the touch-sensitive input device.

13. The method according to claim 9, wherein the touch-sensitive input device is a touch screen.

14. The method according to claim 13, wherein the decision function takes into account objects presented on the touch screen proximal to the X-Y location of the actual finger touches.

15. A non-transitory computer readable medium for estimating an intended position of at least target-inaccurate touch of a user over a touch-sensitive input device comprising a set of instructions that when executed cause at least one processor to:
analyze one or more points of contact applied to a touch-sensitive input device, to derive touch parameters associated with said points of contact;
apply a decision function to said derived touch parameters, to estimate an intended position of the at least one target-inaccurate touch of said user, wherein the decision function is tailored for said user and is further based on user parameters associated with said user; and
override, at a level of the touch-sensitive input device, the actual points of user contact with the estimated intended position of the at least one target-inaccurate touch of said user.

16. The non-transitory computer readable medium according to claim 15, wherein the touch parameters comprise time stamped metrics of at least one of: X-Y position, size, duration, intensity and orientation.

17. The non-transitory computer readable medium according to claim 15, wherein the user parameters comprise at least one of: X-Y drift, multiplicity of touch; intensity, duration, and tremor magnitude.

18. The non-transitory computer readable medium according to claim 15, further comprising obtaining the user parameters via a calibration session that comprises monitoring predefined touch events carried by the user over the touch-sensitive input device.

19. The non-transitory computer readable medium according to claim 15, wherein the touch-sensitive input device is a touch screen.

20. The non-transitory computer readable medium according to claim 19, wherein the decision function takes into account objects presented on the touch screen proximal to the X-Y location of the actual finger touches.
